(19) United States
(12) Patent Application Publication
(10) Pub. No.: US 2025/0200775 A1
(43) Pub. Date: Jun. 19, 2025

(54) METHODS, DEVICES AND SYSTEMS FOR TRANSPARENT OBJECT THREE-DIMENSIONAL RECONSTRUCTION

(71) Applicant: HONG KONG CENTRE FOR LOGISTICS ROBOTICS LIMITED, Pak Shek Kok, New Territories (HK)

(72) Inventors: Yunhui LIU, Pak Shek Kok, New Territories (HK); Kejing HE, Pak Shek Kok, New Territories (HK); Congying SUI, Pak Shek Kok, New Territories (HK)

(21) Appl. No.: 18/876,829

(22) PCT Filed: Jul. 1, 2022
(86) PCT No.: PCT/CN2022/103249

§ 371 Date: Dec. 19, 2024

Related U.S. Application Data
(63) Continuation of application No. 17/643,152, filed on Dec. 7, 2021.
(60) Provisional application No. 63/262,861, filed on Oct. 21, 2021.

(51) Int. Cl. G06T 7/521; G01S 7/481; G01S 17/894; G02B 26/10; G06T 7/55; G06T 7/73; H04N 13/239; H04N 13/254; H04N 13/296

(52) U.S. Cl. CPC G06T 7/521; G01S 7/4817; G01S 17/894; G02B 26/105; G06T 7/55; G06T 7/73; H04N 13/239; H04N 13/254; H04N 13/296; G06T 2207/10028

(57) ABSTRACT

The present application relates to methods, devices and systems for transparent object three-dimensional reconstruction. The system comprises a structure light generation module, an image acquisition module, a control module and a computing module. The computing module acquires image pairs from the image acquisition module; calculates three-dimensional positions of points according to the image pairs; and performs refinement process to extract first-reflection points. The refinement process comprising: when reflection points are obtained by a first camera, the points include a first point and a second point, the first point is closer to reflection spot of laser on galvanometer mirror than the second point, remove the second point; when the first point is not obtained by a second camera, remove the first point; when the second point is obtained by the second camera, retrieve the second point, and when a discrete external virtual contour is formed, remove the discrete external virtual contour.

### CROSS-REFERENCE TO RELATED APPLICATION(S)

This application is a continuation of International Patent Application No. PCT/CN2022/103249 with a filing date of 1 Jul. 2022, and entitled “METHODS, DEVICES AND SYSTEMS FOR TRANSPARENT OBJECT THREE-DIMENSIONAL RECONSTRUCTION”. The content of the aforementioned applications, including any intervening amendments thereto, are incorporated herein by reference.

### TECHNICAL FIELD

The present disclosure relates to a field of three-dimensional reconstruction, and in particular to methods, devices and systems for transparent object three-dimensional reconstruction.

### BACKGROUND

In traditional three-dimensional (3D) reconstruction technology, a 3D object is reconstructed by laser scanning its surface, collecting reflection points from the surface and calculating the position of the points. A 3D model can be built from the points whose positions are known. However, the reconstruction of transparent objects poses a great challenge due to various complex situations of laser transmission inside the transparent object.

### SUMMARY

According to various embodiments of the present disclosure, methods, devices and systems for transparent object three-dimensional reconstruction are provided.

A method for transparent object three-dimensional reconstruction using laser scanning, the method comprising:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

A device for transparent object three-dimensional reconstruction using laser scanning, comprising:
a processor; and
a non-transitory computer readable medium connected to the processor and having stored thereon instructions for causing the processor to:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

A system for transparent object three-dimensional reconstruction using laser scanning, comprising:
a structure light generation module, emits a laser onto the object, and allows the laser to scan across a measured surface of the object;
an image acquisition module, includes a first camera and a second camera, the first camera and the second camera collect feedback image pairs by capturing the laser reflected from the object;
a control module, is responsible for synchronizing the structured light generation and the image acquisition module; and
a computing module, acquires the image pairs from the image acquisition module; calculates three-dimensional positions of points according to the image pairs;
and performs refinement process to extract first-reflection points;
wherein the refinement process comprises:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 is a schematic diagram of a system for transparent object three-dimensional reconstruction according to an embodiment of the present disclosure;

FIG. 2 is a diagram of a first camera according to an embodiment of the present disclosure;

FIG. 3 is a diagram of a second camera according to an embodiment of the present disclosure;

FIG. 4 is a diagram that shows a calibration model of galvanometer mirror according to an embodiment of the present disclosure;

FIG. 5 is a flow chart of a method applied in the system according to an embodiment of the present disclosure;

FIG. 6 is a flow chart of a method applied in the system according to another embodiment of the present disclosure;

FIG. 7 is a flow chart of a refinement process according to an embodiment of the present disclosure;

FIG. 8 is a flow chart of a refinement process according to another embodiment of the present disclosure;

FIG. 9 is a diagram that shows an optical path analysis of S162 according to an embodiment of the present disclosure;

FIG. 10 is a diagram that shows a situation with an ambiguity point;

FIG. 11 is a diagram that shows another situation with an ambiguity point;

FIG. 12 is a diagram that shows an optical path analysis of S164 according to an embodiment of the present disclosure;

FIG. 13 is a diagram that shows an optical path analysis of S166 according to an embodiment of the present disclosure;

FIG. 14 is a diagram that shows a situation with a severe ambiguity point;

FIG. 15 is a diagram that shows an optical path analysis of S168 according to an embodiment of the present disclosure;

FIG. 16 is a flowchart of a method for transparent object three-dimensional reconstruction according to an embodiment of the present disclosure;

FIG. 17 is a flowchart of a method for transparent object three-dimensional reconstruction according to another embodiment of the present disclosure;

FIG. 18 is a flowchart of a method for transparent object three-dimensional reconstruction according to yet another embodiment of the present disclosure;

FIG. 19 is a structural diagram of a device for transparent object three-dimensional reconstruction according to an embodiment of the present disclosure;

FIG. 20 is a photograph of a plastic funnel;

FIG. 21 is a reconstruction result of the plastic funnel shown in FIG. 20;

FIG. 22 is a photograph of stacking water bottles;

FIG. 23 is a reconstruction result of the stacking water bottles shown in FIG. 22.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

In order to understand this application thoroughly, detailed steps and structures will be provided in the description below to explain the technical solution proposed by this application. Preferred embodiments of this application are described in detail below. However, in addition to these details, there may be other embodiments of this application.

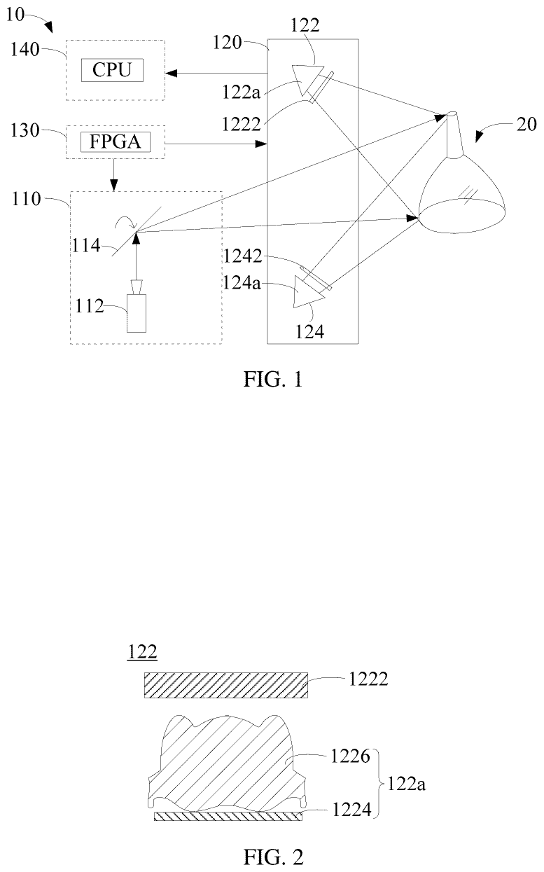

Referring to FIG. 1, a three-dimensional reconstruction system 10 comprises a structure light generation module 110, an image acquisition module 120, a control module 130 and a computing module 140. The system 10 can reconstruct exterior surface of transparent objects 20. The transparent objects 20 can be completely transparent, semi-transparent or partially transparent objects 20.

The structure light generation module 110 emits a laser onto the object 20, and allows the laser to scan across a measured surface of the object 20. In some embodiments, the structure light generation module 110 includes a laser light source 112 and a galvanometer mirror 114, the laser light source 112 emits the laser onto the galvanometer, and the galvanometer reflects the laser onto the object 20. In other embodiments, the structure light generation module 110 can also be other laser devices with controllable direction. In this embodiment, the galvanometer mirror 114 has the single-axis rotation capability, which reflects the laser onto the object 20 to be reconstructed to form designed feature. The laser scans across the measured surface through rotating the galvanometer mirror 114 to continuous preset angles. The galvanometer mirror 114 reflects the laser onto the object 20 to be reconstructed to form the designed feature. In this embodiment, the shape of the laser is a line. In other embodiments, the shape of the laser can be a point or a curve.

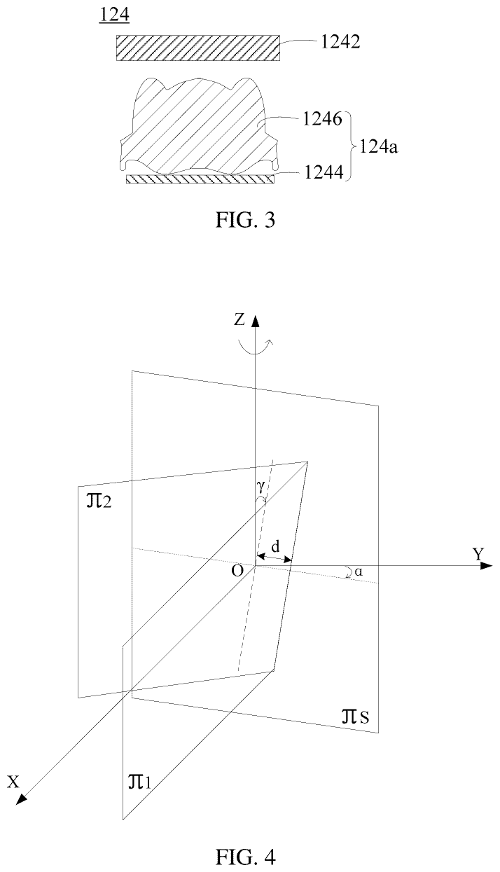

The image acquisition module 120 includes a first camera 122 and a second camera 124, the first camera 122 and the second camera 124 collect feedback image pairs by capturing the laser reflected from the object 20. The image acquisition can transfer the images to the computing module 140. Referring to FIGS. 2 and 3, in some embodiments, the first camera 122 comprises a first camera body 122a and a first optical filter 1222, and the first camera body 122a comprises a first image sensor 1224 and a first optical lens 1226. The first camera 122 comprises a first image sensor 1224, a first optical lens 1226 and a first optical filter 1222, the first optical lens 1226 is between the first image sensor 1224 and the first optical filter 1222. FIGS. 1 and 3, the second camera 124 comprises a second camera body 124a and a second optical filter 1242, and the second camera body 124a comprises a second image sensor 1244 and a second optical lens 1246. The second camera 124 comprises a second image sensor 1244, a second optical lens 1246 and a second optical filter 1242, the second optical lens 1246 is between the second image sensor 1244 and the second optical filter 1242. A wavelength of the laser matches with a pass-through wavelength of the first optical filter 1222 and the second optical filter 1242. The first optical filter 1222 and the second optical filter 1242 allow the laser to the first optical lens 1226 and the second optical lens 1246, avoiding stray light interference.

The control module 130 is responsible for synchronizing the structured light generation and the image acquisition module 120. In some embodiments the control module 130 can synchronize the structured light generation and the image acquisition module 120 through pulse modulation.

The computing module 140 is responsible for analyzing and processing data to reconstruct the exterior surface of the object 20. The reflected laser plane by the galvanometer mirror 114 of the system 10 is modeled according to the principle of light path propagation.

In some embodiments, a calibration procedure is included by the system 10. Referring to FIG. 4, FIG. 4 shows a calibration model of the galvanometer mirror 114. First, the rotation center axis of galvanometer mirror 114 is taken as z-axis. Second, the x-axis is parallel to the line laser incident plane π₁ and perpendicular to the z-axis. The α means the angle between the galvanometer mirror 114 reflection plane πₛ and y-axis. Ideally, the line laser incident plane π₁ crosses the z-axis. Taking the installation deviation into account, two parameters γ and d are created for correct the deviation. γ represents the angle between the intersection line of the π₁ and YOZ plane and z-axis. The π₁ intersects the y-axis at the point (0, d, 0). Then the line laser incident plane π₁ can be expressed as:

$${π}_{1} : y - tan ( γ ) z - d = 0 \qquad ( 1 )$$

The galvanometer mirror 114 reflection plane πₛ is expressed as:

$${π}_{s} : cos ( α ) x - sin ( α ) y = 0 \qquad ( 2 )$$

According to the Householder transformation, the reflection matrix H can be calculated as:

$$H = 1 - 2 {\vec{n}}_{{π}_{s}} {\vec{n}}_{{π}_{s}^{*}} = [ \begin{matrix}- cos ( 2 α ) & sin ( 2 α ) & 0 \\ sin ( 2 α ) & cos ( 2 α ) & 0 \\ 0 & 0 & 1\end{matrix} ] \qquad ( 3 )$$

And the normal vector of reflected laser plane π₁ can be determined as:

$${\vec{n}}_{{π}_{1}} = [ \begin{matrix}0 \\ 1 \\ - tan ( γ )\end{matrix} ] \qquad ( 4 )$$

The normal vector of reflected laser plane π₂ can be derived as:

$${\vec{n}}_{{π}_{2}} = H {\vec{n}}_{{π}_{1}} = [ \begin{matrix}sin ( 2 α ) \\ cos ( 2 α ) \\ - tan ( γ )\end{matrix} ] \qquad ( 5 )$$

The reflected laser plane π₂ crosses the point (dtan (α), d, 0). Therefore, the reflected laser plane π₂ can be obtained as below:

$${π}_{2} : sin ( 2 α ) {x}_{s} - cos ( 2 α ) {y}_{s} - tan ( γ ) {z}_{s} - d = 0 \qquad ( 6 )$$

Suppose the rotation vector \vec{T} and translation vector \vec{t} are the conversion from the camera coordinate system to the galvanometer mirror 114 coordinate system. Therefore, the conversion relationship from the point (x_{c}, y_{c}, z_{c}) in the camera coordinate system to the point (xₛ, yₛ, zₛ) in the galvanometer mirror 114 coordinate system is shown below:

$$[ \begin{matrix}{x}_{s} \\ {y}_{s} \\ {z}_{s} \\ 1\end{matrix} ] = [ \begin{matrix}cos ( θ ) + \frac{{r}_{1}^{2} ( 1 - cos ( θ ) )}{{θ}^{2}} \frac{{r}_{1} {r}_{2} ( 1 - cos ( θ ) )}{{θ}^{2}} - \frac{{r}_{3} sin ( θ ) {r}_{1} {r}_{3} ( 1 - cos ( θ ) )}{\begin{matrix}θ & {θ}^{2}\end{matrix}} + \frac{{r}_{2} sin ( θ )}{θ} \\ \frac{{r}_{1} {r}_{2} ( 1 - cos ( θ ) )}{{θ}^{2}} + \frac{{r}_{3} sin ( θ )}{θ} cos ( θ ) + \frac{{r}_{2}^{2} ( 1 - cos ( θ ) )}{{θ}^{2}} \frac{{r}_{2} {r}_{3} ( 1 - cos ( θ ) )}{{θ}^{2}} - \frac{{r}_{1} sin ( θ )}{θ} \\ \frac{{r}_{2} {r}_{3} ( 1 - cos ( θ ) )}{{θ}^{2}} - \frac{{r}_{2} sin ( θ ) {r}_{2} {r}_{3} ( 1 - cos ( θ ) )}{\begin{matrix}θ & {θ}^{2}\end{matrix}} + \frac{{r}_{1} sin ( θ )}{θ} cos ( θ ) + \frac{{r}_{2}^{2} ( 1 - cos ( θ ) )}{{θ}^{2}} \\ \begin{matrix}0 & 0 & 0\end{matrix}\end{matrix} \begin{matrix}{t}_{1} \\ {t}_{2} \\ {t}_{3} \\ 1\end{matrix} ] [ \begin{matrix}{x}_{c} \\ {y}_{c} \\ {z}_{c} \\ 1\end{matrix} ] \qquad ( 7 )$$

$$Where : θ = \sqrt{{r}_{1}^{2} + {r}_{2}^{2} + {r}_{3}^{2}}$$

The galvanometer mirror 114 coordinate system is not constrained completely, which can move along the rotation center axis of galvanometer mirror 114. The galvanometer mirror 114 coordinate system can be fixed by making t₃=0. For the angle α, it can be controlled by the input current value I as shown in Eq. (8), where k means the linear increased angle of unit current and α₀ means initial bias angle.

$$α ( I ) = kI + {α}_{0} \qquad ( 8 )$$

There are, in total, 9 independent unknown parameters to describe the galvanometer mirror 114 model with no position assumptions. Simultaneously, the assembly error is considered in the mathematical model. The 9 independent unknown parameters can be estimated by minimizing the following objective function:

$$E ( X ) = \frac{{\sum }_{i = 1}^{n} {\sum }_{j = 1}^{m} D ( {P}_{ij} , {π}_{2}^{j} )}{m n} \qquad ( 9 )$$

where D(Pᵢⱼ, π₂^{j}) is the distance from the sample point Pᵢⱼ to the estimated reflected laser plane π₂^{j}. X are the 9 independent parameters to be optimized.

To sum up, the calibration procedure of the system 10 including the galvanometer mirror 114 and the first camera 122 and the second camera 124 (dual-cameras) is described as follows:

First, a checkerboard is put at different poses and captured by the dual-cameras without laser scanning.

Second, the captured images are calibrated for dual-cameras including the intrinsic parameters, extrinsic parameters and distortion coefficients.

Third, the planar target is located at different orientations and captured by dual-cameras with laser scanning.

Fourth, the laser stripe feature points are extracted and reconstructed by binocular triangulation through dual-cameras.

Fifth, the 9 independent parameters are estimated according to Eq. (9). Then, calibration of the system 10 is completed.

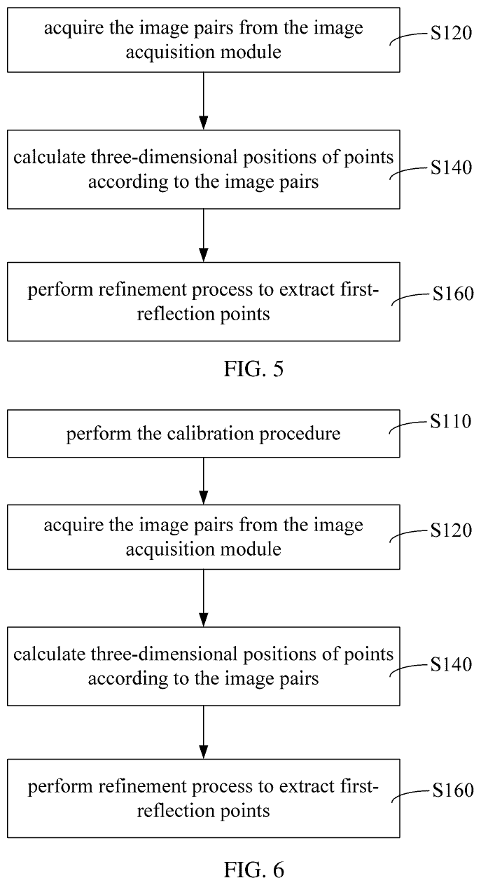

Referring to FIG. 5, the computing module 140 performs the following steps:
Step S120: acquire the image pairs from the image acquisition module 120.
Step S140: calculate three-dimensional positions of points according to the image pairs.
Step S160: perform refinement process to extract first-reflection points.

Then, the 3D point cloud is obtained.

Various situations of laser transmission inside the transparent object 20 are analyzed and the reconstructed 3D laser point candidates are classified into two types: first-reflection points and non-first-reflection points. The first-reflection points means the first reflected laser points on the front surface of measured objects 20.

Referring to FIG. 6, in some embodiments, the computing module 140 performs Step S110 before S120:
Step S110: perform the calibration procedure.

The calibration procedure is described in the above. After performing the calibration procedure, the accuracy of the output will be improved.

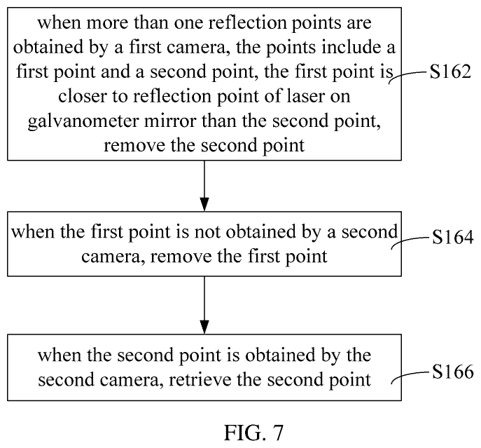

Concretely, referring to FIG. 7, the refinement process comprises:
Step S162: when more than one points are obtained by a first camera 122, the points include a first point and a second point, the first point is closer to reflection spot of laser on galvanometer mirror 114 than the second point, remove the second point;
Step S164: when the first point is not obtained by a second camera 124, remove the first point.
Step S166: when the second point is obtained by the second camera 124, retrieve the second point.

For every row of the image, the number of the first point is one. The number of the second point can be one or more.

In some embodiments, in the step of S166, if the second camera 124 obtained two or more points, the second point is closer to reflection spot of laser on galvanometer mirror 114 than the other point.

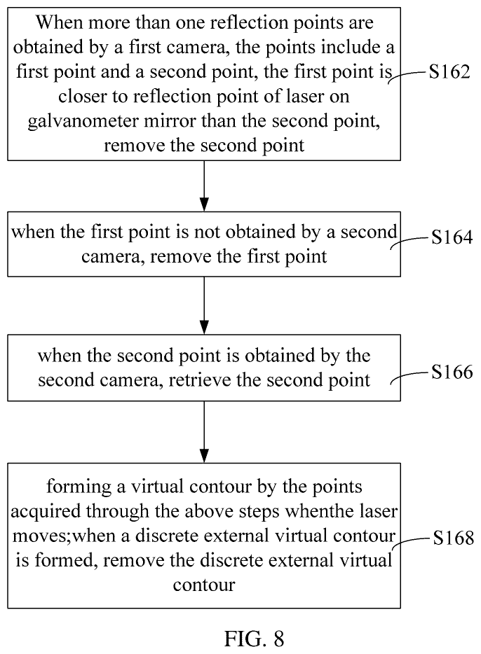

Referring to FIG. 8, in some embodiments, the computing module 140 also performs the following step after S166:
Step S168: form a virtual contour by the points acquired through the above steps when the laser moves; when a discrete external virtual contour is formed, remove the discrete external virtual contour.

The refinement process can reconstruct the exterior surface of a transparent object 20 with unknown interior. The refinement process extracts the first-reflection points through optical geometric constraints. In S162, fake points can be removed by single camera; in S164, ambiguity points can be removed by dual-camera joint constraint; in S166, the missing first-reflection exterior surface point can be retrieved by fusion; and in S168, severe ambiguity points can be removed by contour continuity.

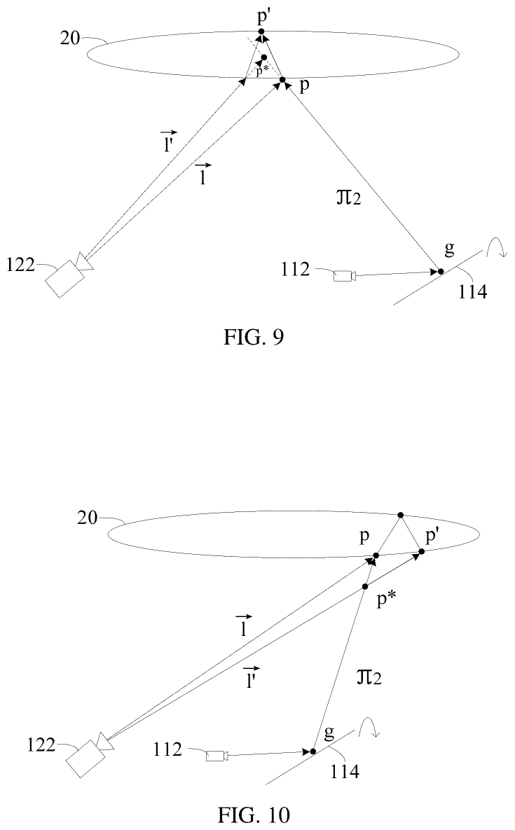

Referring to FIG. 9, in S162, fake points removed by single camera. To achieve the fake points removed by single camera (the first camera 122), the optical path is analyzed first as shown in FIG. 9. When the reflection point g on the galvanometer mirror 114 projects the laser onto the surface point p on the exterior surface of the measured object 20, part of the light is directly reflected into the first camera 122 through ray \vec{l} by diffuse reflection. The remaining light is refracted into the transparent object 20, reflected by the back surface at the point p′, and finally captured by the first camera 122 through ray \vec{l′}. According to the previous calibration results, the incident laser plane π₂ is known. By extracting the feature laser points in the first camera 122 image, the ray \vec{l} and \vec{l′} can be determined. The point candidates p and p* (the first point and the second point) can be calculated according to the triangulation.

When the point candidates p and p* are acquired, the fake point p* can be removed by this restriction Eq. (10). The points TPₗᵢ (True Points) are reserved by S162.

$${p}^{*} = {max}_{p , {p}^{*}} ( gp , g {p}^{*} ) \qquad ( 10 )$$

The fake point p*is farther to reflection point g than the point p. According to S162, remove the fake point p*.

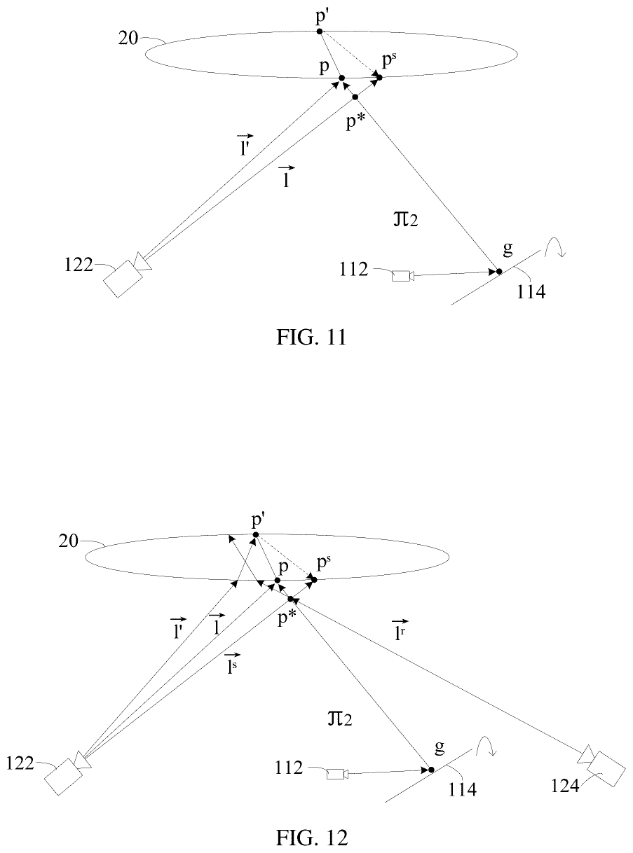

However, there are two situations with ambiguity points which cannot be removed correctly. As shown in FIGS. 10 and 11, due to the refraction and reflection of laser light inside transparent objects 20, the non-first-reflection points can include the reflected laser point p′ from the rear surface and some permanent spots p^{s} on the exterior surface. The laser point p′ can be produced from the mirror-reflection on the rear surface of measured objects 20. The permanent spot p^{s} on the exterior surface is created because of the complex cross-reflection inside the transparent objects 20 and it is stationary when laser moves, which is displayed as the dotted line in FIG. 11. In these two situations, the first-reflection exterior point p is removed and the ambiguity point p* is reserved incorrectly by the restriction Eq. (10). To solve this ambiguity problem, S164 and S166 are adopted to remove the ambiguity points p* and retrieve the first-reflection exterior point p.

To guarantee the reliability of the reconstruction points, the ambiguity points p*are removed by S164. As shown in FIG. 12, the images of the second camera 124 are draw into consideration to provide the second angle of view information. For the second camera 124, the ambiguity points p* and the second camera 124 center Cᵣ form another ray \vec{l^{r}}. The second camera 124 receives no light intensity through optical path. Therefore, the ambiguity points p* cannot be categorized into feature laser point by the second camera 124. The reserved true points TPₗᵢ are reprojected to the second camera 124 plane as shown below:

$$t {p}_{r i} = reproject ( {TP}_{l i} , {C}_{r} ) \qquad ( 11 )$$

Through this reprojection, the 2D coordinate of points tpᵣᵢ are obtained in the second camera 124 plane. Then the ambiguity points p* are removed by determining whether the tpᵣᵢ are feature laser points. As shown in Eq. (12), CTPₗᵢ (Confident True Points) are obtained by removing the ambiguity points p* through reprojection and re-judgement on the second camera 124 plane.

$${CTP}_{li} = {Compare}_{T {P}_{li}} ( {R}_{i} ( t {p}_{r i} ) , thr ) \qquad ( 12 )$$

In S162, the ambiguity situations cause the first-reflection exterior point p removed and the ambiguity point p* reserved incorrectly as shown in FIGS. 10 and 11. S164 removes the ambiguity points p* through reprojection and re-judgement on the second camera 124 plane. In S166, the first-reflection exterior points p will be retrieved through fusing the result from the second camera 124 view.

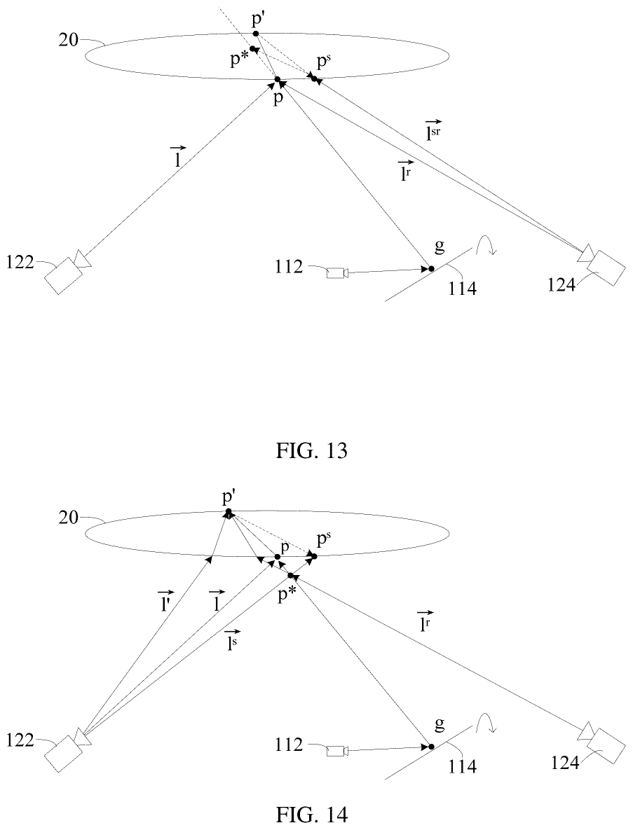

As shown in FIG. 13, the removed points p in S162 by the first camera 122 can be retrieved by the second camera 124. In the second camera 124 view, the first-reflection exterior point p is retained through this restriction Eq. (10) and it also passed the S164. Then, in S166, the removed point p by the first camera 122 can be retrieved by fusing dual-camera results as shown in Eq. (13).

$$CTP = fuse ( {CTP}_{l i} , CT {P}_{r i} ) \qquad ( 13 )$$

However, there is one situation with severe ambiguity points as shown in FIG. 14. In this situation, the ambiguity points p* and the second camera 124 center form another ray \vec{l^{r}}. Coincidentally, the second camera 124 receives the intensity from point p′ through ray \vec{l^{r}}. Therefore, the ambiguity points p* cannot be removed by the second camera 124 information. It is worth noting that this situation rarely happens and the phenomenon disappears automatically when laser moves. These severe ambiguity points form discrete external virtual contours, which can be removed by S168. The computing module 140 forms a virtual contour by the points acquired through the above steps when the laser moves. When a discrete external virtual contour is formed, remove the discrete external virtual contour.

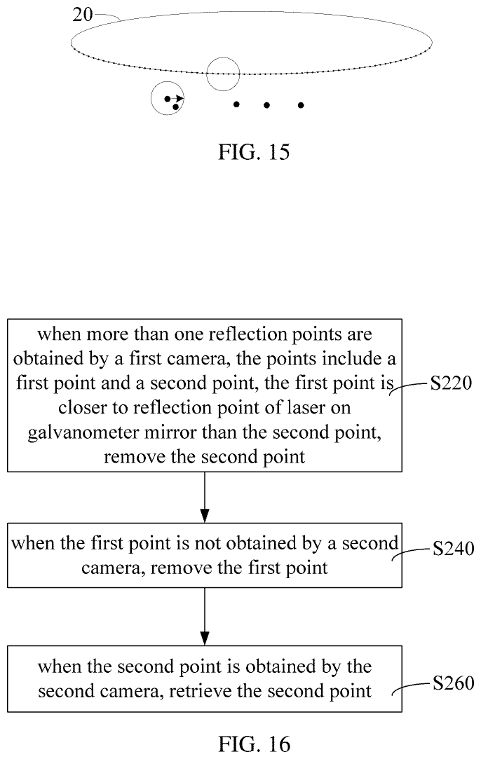

As analyzed above, the severe ambiguity points form discrete external virtual contours. According to the contour continuity, the discrete external virtual contours can be removed by Eq. (14) as shown in FIG. 15.

$$Result = {filter}_{O u t l i e r ( CTP , {min}_{pts} , radius )} \qquad ( 14 )$$

The parameter radius means the point neighboring search radius range and the parameter minₚₜₛ means the minimum number of points in the search range. That means, in some embodiments, when the point has less neighboring points in a preset search range than a preset number, remove the point.

According to another aspect of the present invention, the present invention further provides a method for transparent object 20 three-dimensional reconstruction using laser scanning. As shown in FIG. 16, the method for transparent object 20 three-dimensional reconstruction using laser scanning in this embodiment includes:
Step S220: when reflection points are obtained by a first camera 122, the points include a first point and a second point, the first point is closer to reflection spot of laser on galvanometer mirror 114 than the second point, remove the second point.
Step S240: when the first point is not obtained by a second camera 124, remove the first point.
Step S260: when the second point is obtained by the second camera 124, retrieve the second point.

For every row of the image, the number of the first point is one. The number of the second point can be one or more.

In some embodiments, in the step of S260, if the second camera 124 obtained two or more points, the second point is closer to reflection spot of laser on galvanometer mirror 114 than the other point.

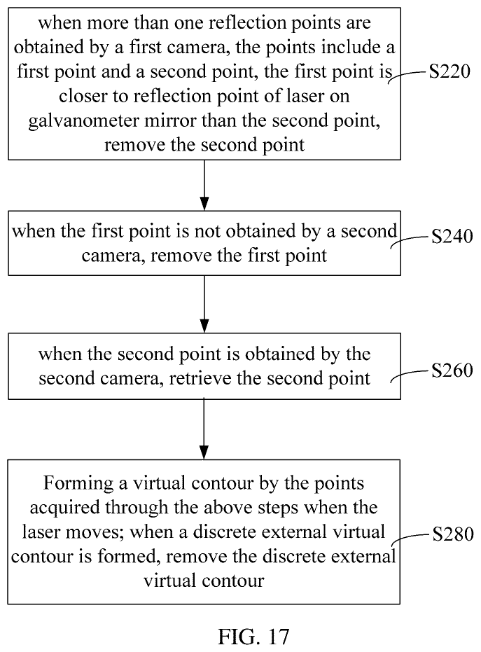

Referring to FIG. 17, in some embodiments, the method also includes the following step after S260:
Step S280: form a virtual contour by the points acquired through the above steps when the laser moves; when a discrete external virtual contour is formed, remove the discrete external virtual contour.

The refinement process can reconstruct the exterior surface of a transparent object 20 with unknown interior. The refinement process extracts the first-reflection points through optical geometric constraints. In S220, fake points can be removed by single camera; in S240, ambiguity points can be removed by dual-camera joint constraint; in S260, the missing first-reflection exterior surface point can be retrieved by fusion; and in S280, severe ambiguity points can be removed by contour continuity. As severe ambiguity points rarely appear, the S280 can be omitted.

In some embodiments, S280 comprises the step of when the point has less neighboring points in a preset search range than a preset number, remove the point. The preset search range can be a preset search radius range. In other embodiments, the preset search range also can be a square range or a triangle range.

In some embodiments, the method shown in FIGS. 16 and 17 can be applied to, but limited to, electronic devices such as computers, smart phones, personal digital assistants, so as to enable three-dimensional reconstruction system 10s to reconstruct transparent objects 20. In some embodiments, the method shown in FIGS. 16 and 17 can be applied to three-dimensional reconstruction system 10 straight forward.

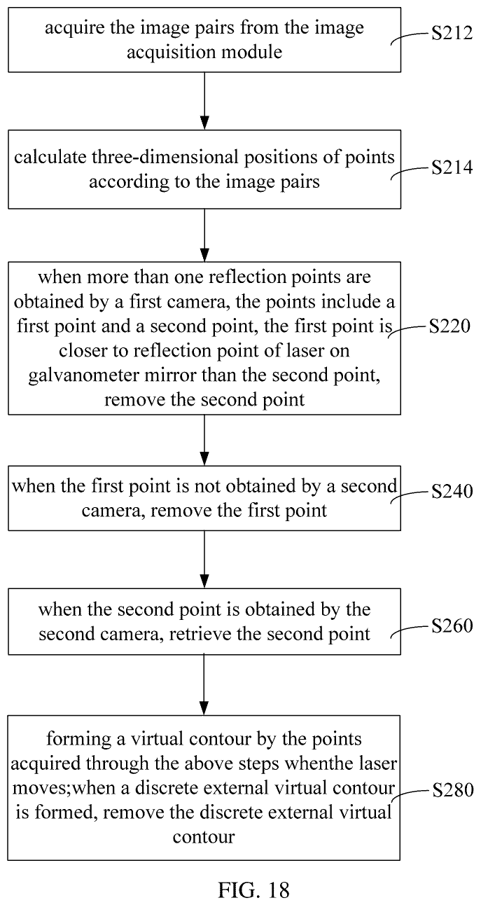

Referring to FIG. 18, in some embodiments, the method also includes the following step before S220:
Step S212: acquire image pairs from by the first camera 122 and the second camera 124.
Step S214: calculate three-dimensional positions of the points according to the image pairs.

In S214, calibration parameters and triangulation also can be considered to calculate three-dimensional positions of the points in some embodiments. As described above in embodiments, the calibration parameters can be obtained by minimizing objective function.

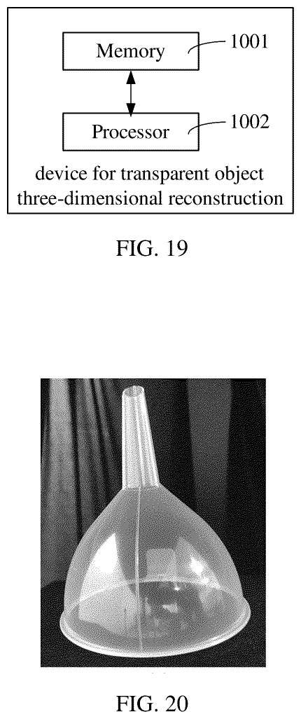

According to another aspect of the present invention, the present invention further provides a device for transparent object 20 three-dimensional reconstruction using laser scanning. As shown in FIG. 19, the device for transparent object 20 three-dimensional reconstruction using laser scanning in this embodiment includes: a memory 1001 and a processor 1002.

The processor 1002 is configured to when reflection points are obtained by a first camera 122, the points include a first point and a second point, the first point is closer to reflection spot of laser on galvanometer mirror 114 than the second point, remove the second point. Fake points can be removed by single camera.

The processor 1002 is further configured to when the first point is not obtained by a second camera 124, remove the first point. Ambiguity points can be removed by dual-camera joint constraint.

The processor 1002 is further configured to when the second point is obtained by the second camera 124, retrieve the second point. The missing first-reflection exterior surface point can be retrieved by fusion.

The processor 1002 is further configured to acquire image pairs from by the first camera 122 and the second camera 124, and calculate three-dimensional positions of the points according to the image pairs.

The processor 1002 is further configured to form a virtual contour by the points acquired through the above steps when laser moves; when a discrete external virtual contour is formed, remove the discrete external virtual contour. Wherein when the point has less neighboring points in a preset search range than a preset number, remove the point. Severe ambiguity points can be removed by contour continuity.

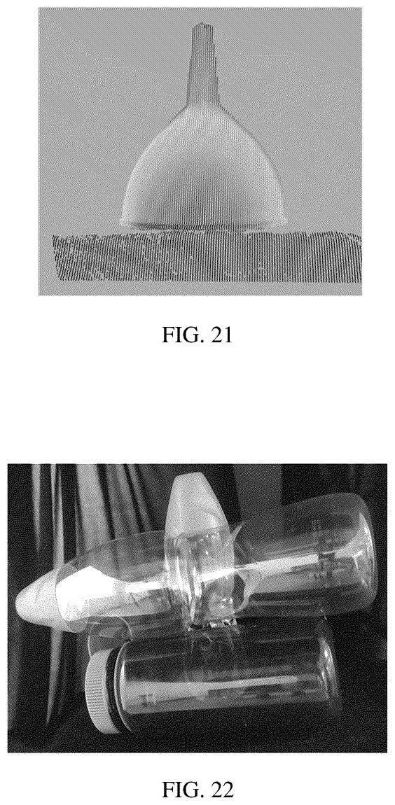

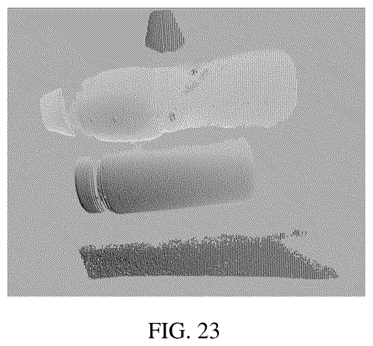

To validate the performance of the proposed method, an experiment was carried out on the system 10. The structure light generation module 110 includes a line laser and a galvanometer mirror 114 with single-axis rotation capability. The line laser scans across the measured surface through rotating the galvanometer mirror 114 to continuous setting-angles. Simultaneously, the image acquisition module 120 includes the first camera 122 with the first optical filter 1222 and the second camera 124 with the second optical filter 1242 is synchronized to capture the image pairs and transfer them to the computing module 140. Then, the refinement process is adopted to the obtained images. The reconstruction of a plastic funnel and stacking water bottles are shown in FIGS. 20 to 23. The experimental result on real object 20 demonstrates that the method can successfully extract the first-reflection points from the candidates and recover the complex shapes of transparent and semitransparent objects 20.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure. Therefore, the protection scope of the disclosure is subject to the protection scope of the appended claims.

What is claimed is:

1. A method for transparent object three-dimensional reconstruction using laser scanning, the method comprising:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

2. The method of claim 1, wherein
before the step of when reflection points are obtained by a first camera, the points include a first point and a second point, the first point is closer to reflection spot of laser on galvanometer mirror than the second point, remove the second point, the method further comprises:
acquire image pairs from by the first camera and the second camera, and
calculate three-dimensional positions of the points according to the image pairs.

3. The method of claim 2, wherein
the step of calculate three-dimensional positions of the points according to the image pairs, comprises:
calculate three-dimensional positions of the points according to the image pairs, calibration parameters and triangulation.

4. The method of claim 3, wherein the calibration parameters are obtained by minimizing objective function.

5. The method of claim 1, further comprising:
when the first point is not obtained by the second camera, remove the first point which is an ambiguity point.

6. The method of claim 5, further comprising:
after removing the ambiguity point, when the second point is obtained by the second camera, retrieve the second point, if the second camera obtained two or more points, the second point is closer to reflection spot of laser on galvanometer mirror than the other point.

7. The method of claim 1, further comprising:
Form a virtual contour by the points acquired through the above steps when laser moves;
when a discrete external virtual contour is formed, remove the discrete external virtual contour.

8. The method of claim 7, wherein
the step of when a discrete external virtual contour is formed, remove the discrete external virtual contour, comprises:
when the point has less neighboring points in a preset search range than a preset number, remove the point.

9. The method of claim 1, wherein
in the step of when the second point is obtained by the second camera, retrieve the second point, comprises:
if the second camera obtained two or more points, the second point is closer to reflection spot of laser on galvanometer mirror than the other point.

10. A device for transparent object three-dimensional reconstruction using laser scanning, comprising:
a processor; and
a non-transitory computer readable medium connected to the processor and having stored thereon instructions for causing the processor to:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

11. The device of claim 10, wherein
before the step of when reflection points are obtained by a first camera, the points include a first point and a second point, the first point is closer to reflection spot of laser on galvanometer mirror than the second point, remove the second point;
the non-transitory computer readable medium further has stored thereon instructions for causing the processor to:
acquire image pairs from by the first camera and the second camera, and
calculate three-dimensional positions of the points according to the image pairs.

12. The device of claim 10, wherein the non-transitory computer readable medium further has stored thereon instructions for causing the processor to:
form a virtual contour by the points acquired through the above steps when laser moves;
when a discrete external virtual contour is formed, remove the discrete external virtual contour.

13. A system for transparent object three-dimensional reconstruction using laser scanning, comprising:
a structure light generation module, emits a laser onto the object, and allows the laser to scan across a measured surface of the object;
an image acquisition module, includes a first camera and a second camera, the first camera and the second camera collect feedback image pairs by capturing the laser reflected from the object;
a control module, is responsible for synchronizing the structured light generation and the image acquisition module; and
a computing module, acquires the image pairs from the image acquisition module;
calculates three-dimensional positions of points according to the image pairs; and
performs refinement process to extract first-reflection points;
wherein the refinement process comprises:
when reflection points are obtained by a first camera, the points include a first point and a second point, the first point is closer to reflection spot of laser on galvanometer mirror than the second point, remove the second point;
when the first point is not obtained by a second camera, remove the first point; and
when the second point is obtained by the second camera, retrieve the second point.

14. The system of claim 13, wherein the computing module forms a virtual contour by the points acquired through the above steps when the laser moves;
when a discrete external virtual contour is formed, the computing module removes the discrete external virtual contour.

15. The system of claim 14, where in the step of when a discrete external virtual contour is formed, removes the discrete external virtual contour, comprise:
when the point has less neighboring points in a preset search range than a preset number, the computing module removes the point.

16. The system of claim 13, wherein the structure light generation module includes a laser light source and a galvanometer mirror;
the laser light source emits the laser onto the galvanometer, the galvanometer reflects the laser onto the object.

17. The system of claim 16, wherein the galvanometer mirror has the single-axis rotation capability, the laser scans across the measured surface through rotating the galvanometer mirror to continuous preset angles.

18. The system of claim 16, wherein the shape of the laser is a point, a line or a curve.

19. The system of claim 13, wherein the first camera comprises a first image sensor, a first optical lens and a first optical filter, the first optical lens is between the first image sensor and the first optical filter;
the second camera comprises a second image sensor, a second optical lens and a second optical filter, the second optical lens is between the second image sensor and the second optical filter;
a wavelength of the laser matches with a pass-through wavelength of the first optical filter and the second optical filter.

20. The system of claim 13, wherein the control module is responsible for synchronizing the structured light generation and the image acquisition module through pulse modulation.
